(19) United States
(12) Patent Application Publication
(10) Pub. No.: US 2022/0008811 A1
(43) Pub. Date: Jan. 13, 2022

(54) BRAKING SYSTEM, AXLE SUPPORT UNIT FOR A VEHICLE, VEHICLE HAVING SUCH AN AXLE SUPPORT UNIT AND DRIVE UNIT

(71) Applicant: Schaeffler Technologies AG & Co. KG, Herzogenaurach (DE)

(72) Inventors: Simon ORTMANN, Baden-Baden (DE); Marcel Philipp MAYER, Singapore (SG); Jannick Dominik Herbert ALTHERR, Singapore (SG)

(73) Assignee: Schaeffler Technologies AG & Co. KG, Herzogenaurach (DE)

(21) Appl. No.: 17/293,119

(22) PCT Filed: Oct. 9, 2019
(86) PCT No.: PCT/DE2019/100873

§ 371 Date: May 12, 2021

(30) Foreign Application Priority Data
Nov. 16, 2018 (DE) 10 2018 128 771.2

(51) Int. Cl. A63C 17/14; B60B 27/00; B60B 3/00; A63C 17/01; F16D 65/12

(52) U.S. Cl. CPC A63C 17/1427; B60B 27/0052; F16D 65/123; A63C 17/015; B60B 3/001

(57) ABSTRACT

A braking system having a rotating element that rotates about an axis, and a braking device for braking the rotating element. The braking device has a first braking element that is movable between a rest position and a braking position and has an annular braking surface which is arranged concentrically with respect to the axis and has a brake disc which is co-rotationally connected to the rotating element and has first and second frictional surfaces. The annular braking surface of the first braking element is arranged at a distance from the brake disc in the rest position, and is in contact with the first frictional surface thereof in the braking position. A second braking element is arranged such that in the braking position the first braking element presses the brake disc against the second braking element such that the second braking element is in contact with the second frictional surface.

### CROSS-REFERENCE TO RELATED APPLICATIONS

This application is the U.S. National Phase of PCT Appln. No. PCT/DE2019/100873, filed Oct. 9, 2019, which claims priority to DE 10 2018 128 771.2, filed Nov. 16, 2018.

### TECHNICAL FIELD

The disclosure relates to a braking system having at least one rotating element rotatable about an axis and a braking device for braking the rotating element, wherein the braking device has a first braking element which can be moved between a rest position and a braking position and has an annular braking surface which is arranged concentrically to the axis of the rotating element in the rest position and in the braking position. The disclosure also relates to an axle support unit for a vehicle, in particular for a skateboard, bicycle, or motorcycle, having such a braking system. Another object of the disclosure is a vehicle having such an axle support unit. The disclosure also relates to a drive unit having an aforementioned braking system, wherein the rotating element of the braking system is formed as a drive element, in particular a drive wheel or drive pinion.

### BACKGROUND

A vehicle designed as a skateboard is known, for example, from U.S. Pat. No. 6,659,480 B1. This skateboard has an axle support unit with two wheels as the rear axle, on which a braking device for braking the wheels is arranged. Each wheel is assigned a braking element which has an annular braking surface which is arranged concentrically to the axis of the respective wheel. The braking element can be moved, via a pivotable lever, from a rest position at a distance from the respective wheel into a braking position in which the respective braking element is in contact with a braking surface, co-rotationally connected to the wheel.

In braking systems having such braking devices, it has been found to be disadvantageous that the axially acting braking force applied to the braking surface by the braking element is introduced into the wheel. When braking, large axial forces therefore act on the roller bearings that support the wheel. This reduces the service life of such systems, in particular the roller bearings of such systems.

### SUMMARY

Against this background, the object arises of specifying a braking system of the type mentioned above, having an increased service life.

The object is achieved by a braking system having at least one rotating element rotatable about an axis and a braking device for braking the rotating element, wherein the braking device has a first braking element which can be moved between a rest position and a braking position and has an annular braking surface which is arranged concentrically to the axis of the rotating element in the rest position and in the braking position, having a brake disc co-rotationally connected to the rotating element, having a first frictional surface and a second frictional surface opposite the first frictional surface, wherein the annular braking surface of the first braking element is arranged at a distance from the brake disc in the rest position and is in contact with the first frictional surface of the brake disc in the braking position, and having a second braking element which is arranged such that the first braking element presses the brake disc against the second braking element in the braking position so that the second braking element is in contact with the second frictional surface of the brake disc in the braking position.

In the braking system according to the disclosure, the brake disc co-rotationally connected to the rotating element is clamped between the first and the second braking elements in the braking position. This can prevent forces acting in the axial direction from being introduced into the rotating element. In particular, forces acting in the roller bearings or their rolling elements in the axial direction during braking can be reduced. This can increase the service life of the braking system.

The brake disc is preferably formed annular and arranged concentrically to the axis of rotation. The first and second frictional surfaces of the brake disc can be configured to be annular.

According to an advantageous embodiment, the first braking element can be hydraulically moved between the rest position and the braking position. In such a configuration, hydraulic pressure is applied to the first braking element for movement between the rest position and the braking position, allowing for a more uniform distribution of the pressure force required for braking. This also distributes the force introduced into the brake disc more uniformly. The risk of overstressing individual areas of the brake disc can be reduced in this manner. This reduces the likelihood of premature failure of the wheel bearing and further increases the service life of the vehicle.

According to an advantageous embodiment it is provided that the first braking element is connected to a hollow-cylindrical brake piston which is mounted in a housing which has a hollow-cylindrical interior for receiving a hydraulic fluid. Such a configuration has the advantage that less installation space is required compared to a braking device which has a lever or a lever mechanism for actuating the first braking element. The housing can be arranged concentrically to the axis of the wheel and/or concentrically to an axle portion of the axle support unit. Optionally, the first braking element can be integrally formed with the brake piston.

It is advantageous if the housing is clamped onto an axle portion of the braking system or the axle support unit so that no connecting elements are required to connect the housing to the axle portion. This allows the number of parts required for assembly to be reduced, also reducing material costs. Preferably, the housing is alternatively or additionally clamped onto a stator portion of a motor via which the rotating element is drivable.

Alternatively, the first braking element can preferably be moved between the rest position and the braking position by an electric motor. As a further alternative, it can be provided that the first braking element can be mechanically moved between the rest position and the braking position.

According to an advantageous embodiment, it is provided that the braking device has one or more leaf springs, by means of which the first braking element can be moved from the braking position back into the rest position. The one or more leaf springs are preferably connected to the first braking element and to the housing of the braking device.

In this context, it is advantageous if the one or more leaf springs extend around the axis of the rotating element in a circumferential direction. As a result of this alignment of the leaf springs, the one or more leaf springs can absorb a torque that occurs during braking. The one or more leaf springs can thus form an essentially wear-free torque support.

The one or more leaf springs are preferably connected to each of the housing and the first braking element by means of a rivet. The respective rivet particularly preferably has an internal thread into which a screw can be screwed. This makes it possible to arrange the leaf spring on a pressure-sensitive housing, for example a housing made of plastic, by means of the rivet.

According to an advantageous embodiment, the second braking element is annular and has first form-fitting elements on an inner contour, which cooperate with corresponding second form-fitting elements on an outer contour of the housing such that the second braking element is secured against rotation about the axis of rotation. The first form-fitting elements can be formed as teeth or wedges. The second form-fitting elements can accordingly be configured as corresponding teeth or wedges.

According to an alternative advantageous embodiment, it is provided that the second braking element is integrally connected to a hollow-cylindrical assembly area which is arranged concentrically around the axis and is surrounded concentrically by the housing. The hollow-cylindrical assembly area is particularly preferably connected, in particular via a securing ring, to the housing on a side of the housing that faces away from the second braking element.

It is also advantageous if the brake disc is annular and has third form-fitting elements on an outer contour, in particular formed as teeth or wedges, which interact with corresponding fourth form-fitting elements on an inner contour of the rotating element such that the brake disc is secured against rotation about the axis of rotation.

Another subject matter of the disclosure is an axle support unit for a vehicle, in particular for a skateboard, bicycle, or motorcycle, having a braking system described above, wherein the rotating element of the braking system is formed as a wheel.

The axle support unit preferably has two wheels, rotatable about the axis of rotation, and two braking devices for braking the wheels. Each of the wheels can have its own motor for driving the respective wheel. The motors are preferably formed as electric motors.

The disclosure also relates to a vehicle, in particular a skateboard, bicycle, or motorcycle, having an axle support unit described above.

The vehicle preferably has a base body to which one or more axle support units are connected. The base body can be formed as a board or plate, for example. The base body can provide a standing surface for a user of the vehicle.

Another subject matter of the disclosure is a drive unit having a braking system described above, wherein the rotating element of the braking system is formed as a drive element, in particular a drive wheel or drive pinion.

For the drive unit, the same advantages can be achieved as have been described in connection with the braking system or the axle support unit. Such a drive unit can be used, for example, in an industrial system, such as a manufacturing system, a robot, or a conveyor system.

The drive wheel or drive pinion is preferably connected to a motor, in particular an electric motor, which is arranged such that the motor can cause a movement of the drive wheel or drive pinion with respect to an axle portion of the braking system. The motor can be formed, for example, as a wheel hub drive, in particular as a direct drive.

### BRIEF DESCRIPTION OF THE DRAWINGS

Further details and advantages of the disclosure will be explained below with reference to the exemplary embodiment shown in the drawings. In the figures:

FIG. 1 shows an exemplary embodiment of a vehicle according to the disclosure in a schematic top view;

FIG. 2 shows an exemplary axle support unit with two braking systems in a perspective representation;

FIG. 3 shows a perspective sectional representation of a first braking system according to FIG. 2, wherein the sectional plane contains the axis of the wheel;

FIG. 4 shows a sectional representation of a second braking system according to FIG. 2, wherein the sectional plane contains the axis of the wheel;

FIG. 5 shows a detailed sectional representation of the second braking system according to FIG. 4;

FIG. 6 shows a perspective representation of a rotating element formed as a wheel;

FIGS. 7-9 show several perspective representations or sectional representations of parts of a braking system according to a first exemplary embodiment;

FIGS. 10-11 show several perspective representations or sectional representations of parts of a braking system according to a second exemplary embodiment.

### DETAILED DESCRIPTION

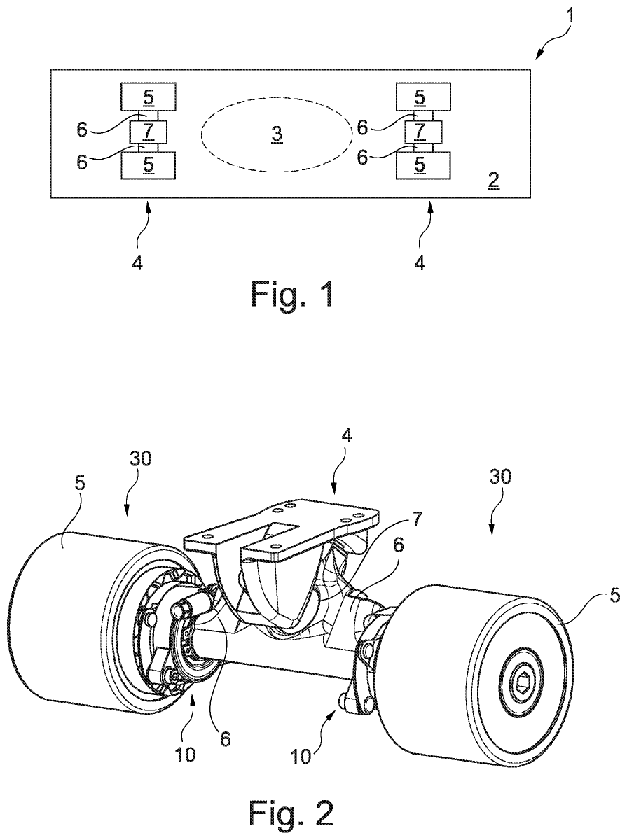

FIG. 1 shows a schematic top view of an exemplary embodiment of a vehicle 1 according to the disclosure, which is formed as a skateboard. The vehicle 1 has a base body 2 which is configured as a board and, on an upper side, provides a standing surface 3 for a user of the vehicle 1. On an underside of the base body 2 opposite the upper side, exactly two axle support units 4 are arranged, which are formed with two tracks, i.e., each axle support unit 4 comprises exactly two rotating elements formed as wheels 5. In the exemplary embodiment, the wheels 5 are formed as rollers, e.g., as hard rubber rollers or polyurethane rollers. The axle support units 4 each have two axle portions 6, with each axle portion 6 carrying one of the wheels 5. The axle support units 4 are each connected to the base body 3 via a tilting device 7. These tilting devices 7 allow the axle support units 4 to be tilted or pivoted relative to the base body 2 so that the vehicle 1 can be cornered by shifting the driver's weight on the standing surface 3.

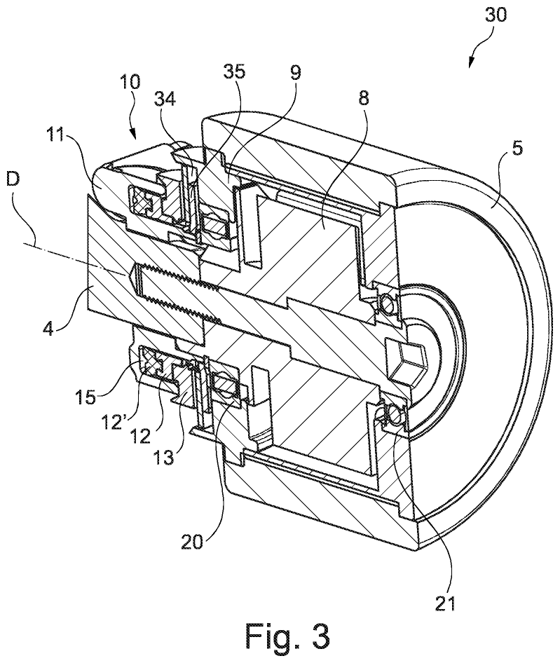

FIG. 2 shows an embodiment of an axle support unit 4 which can be used in the vehicle 1 according to FIG. 1, for example, as a rear axle. Alternatively or additionally, such an axle support unit 4 can be used as the front axle of the vehicle 1. The axle support unit 4 has two wheels 5, rotatable about an axis D, wherein a braking device 10 for braking the respective wheel 5 is assigned to each of the two wheels 5. The wheels 5 are each rotatably arranged on one of two axle portions 6 of the axle support unit 4. The braking device 10 comprises a first braking element 13 which can be moved between a rest position shown in FIGS. 3, 4, and 5, in which an annular braking surface 13.1 of the first braking element 13 is arranged concentrically to the axis D and at a distance from the wheel 5 and remote from the wheel 5, and a braking position in which the braking surface 13.1 of the first braking element 13 is in contact with a brake disc 34 co-rotationally connected to the wheel 5. In the rest position, the braking surface 13.1 of the first braking element 13 is spaced apart from the brake disc 34 so that the first braking element 13 cannot cause any effect that slows the rotational movement of the wheel 5. If, on the other hand, the braking surface 13.1 of the first braking element 13 is in contact with the brake disc 34, a rotational movement of the wheel 5 can be slowed by means of the annular braking surface 13.1.

In this respect, the axle support unit 4 comprises two identically configured braking systems 30, in which the rotating element is each formed as a wheel 5.

In order to achieve the most uniform possible distribution of the pressure force required for braking, the first braking element 13 can be hydraulically moved between the rest position and the braking position. As a result, the risk of overstressing individual areas of the brake disc 43 or the wheel bearings can be reduced so that an increased service life of the vehicle can be achieved. The brake disc 34 has a first frictional surface 34.1 and a second frictional surface 34.2 opposite the first frictional surface 34.1. In the braking position, the first braking element 13, in particular the braking surface 13.1, is in contact with the first frictional surface 34.1 of the brake disc 34. In addition, the braking system 10 has a second braking element 35, which is arranged such that the first braking element 13 presses the brake disc 34 in the braking position against the second braking element 35 so that the second braking element 35 is in contact with the second frictional surface 34.2 of the brake disc 34 in the braking position. The brake disc 34, which is co-rotationally connected to the wheel 5, is thus clamped between the first braking element 13 and the second braking element 35 in the braking position. This can prevent forces acting in the axial direction, i.e., in the direction of the axis D, from being introduced into the wheel 5. Furthermore, forces during braking, acting in the axial direction in the roller bearings 20, 21, supporting the wheel 5, are reduced.

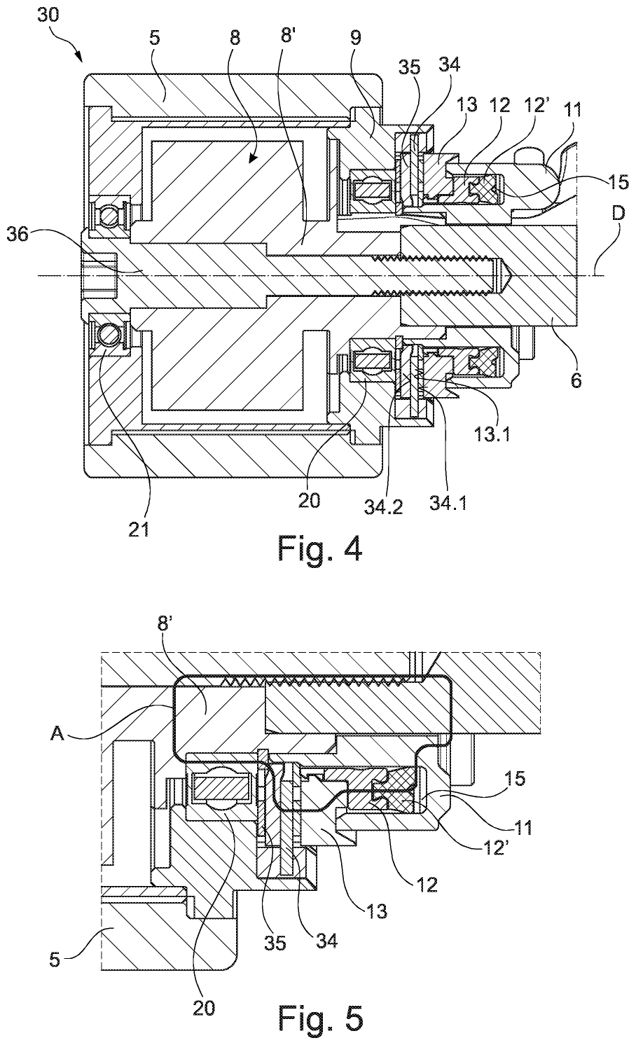

As can be seen from the representations in FIGS. 3 and 4, the braking device 10 is formed in the manner of a hydraulic clutch brake. The braking device 10 has a hollow-cylindrical brake piston 12 which is connected to the first braking element 13 and which is mounted in a housing 11 which has a hollow-cylindrical interior 15 for receiving a hydraulic fluid. The interior 15 is sealed off by a sealing element 12′ connected to the brake piston 12. The housing 11 is clamped onto the axle portion 6 of the axle support unit 4 and is arranged concentrically to the axis D of the wheel or to the axle portion 6. A hydraulic pressure can be exerted on the brake piston 12, and thus on the first braking element 13, via the hydraulic fluid present in the interior 15. The housing 11 has a fluid connection, not shown in the drawings, for introducing the hydraulic fluid. In addition, a ventilation connection can be provided.

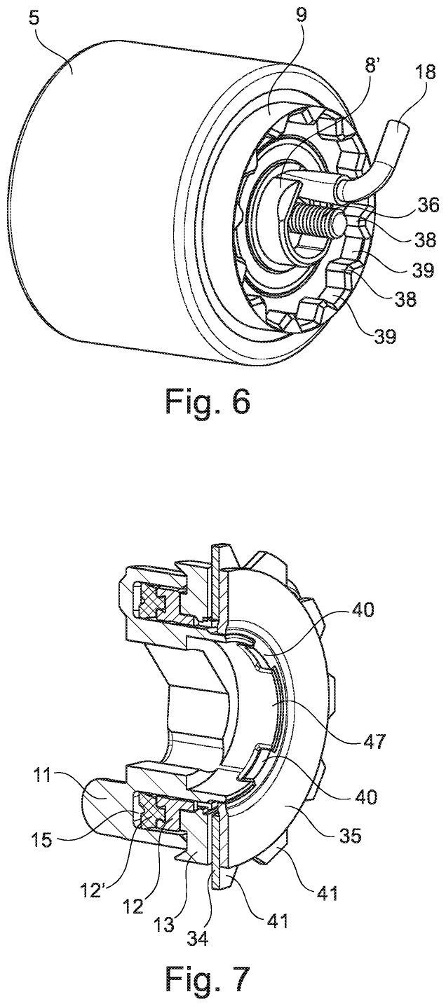

The brake disc 34 is co-rotationally connected to the wheel 5. A motor 8 for driving the wheel 5 is arranged within the wheel 5. The motor 8 is formed as an electric motor and has a stator firmly connected to the axle portion 6, and a rotor 9, which is rotatable relative to the stator and which is co-rotationally connected to the brake disc 34. The stator of the motor 8 is fastened to the axle portion 6 by means of a screw 36. For the rotatable mounting of the wheel 5, a first bearing 20 is provided on an inside of the wheel 5 and a second bearing 21 is provided on an outside of the wheel 5. The first bearing 20 and/or the second bearing 21 are configured as roller bearings. The housing 11 of the braking device has an opening, not shown in the drawings, through which a cable 18 is guided parallel to the axis D, see also FIG. 6. The motor 8 can be supplied with electrical energy and/or electrically controlled via the cable 18.

FIG. 5 shows a detail in the area of the brake disc 34 in an enlarged representation. The first braking element 13 is in the rest position, in which the first braking element 13 is not in contact with the brake disc 34. In the rest position of the first braking element 13, the second braking element 35 is also preferably not in contact with the brake disc 34 but is separated therefrom by a gap. Even though FIG. 5 shows the rest position of the first braking element 13, a force flow path A, which exists in the braking position of the first braking element 13, is drawn in this representation. In this braking position, the first braking element 13 is in contact with the first frictional surface 34.1 of the brake disc 34 and presses the brake disc 34 against the second braking element 35 such that it is in contact with the second frictional surface 34.2 of the brake disc 34. It can be seen that the force flow path A extends through the sealing element 12′, the brake piston 12, the first braking element 13, the brake disc 34, the second braking element 35, the stationary bearing ring of the inner roller bearing 20, a region of the stator 8′, the screw 36, the axle portion 6, and the housing 11 of the braking device. The rolling elements of the inner roller bearing 20 are not stressed.

FIG. 6 shows the rotating element of the braking system 30 formed as a wheel 5. On an inner end face of the rotor 9 of the motor 8, which is connected to the wheel 5, an inner contour is provided that has several form-fitting elements 38. These are formed as teeth and separated from one another by bulges 39.

As can be seen from the representation in FIG. 7, the annular brake disc 34 has an outer contour on which form-fitting elements 41, likewise configured as teeth, are provided. The form-fitting elements 40 on the outer contour of the brake disc 34, in the assembled state, interact with the form-fitting elements on the inner contour of the rotor 9 and cause the brake disc 34 to be secured against rotation about the axis D.

It can also be seen that the second braking element 35 is formed in the manner of an annular stop and is firmly connected to the housing 11 of the braking device 10. The second braking element 35 has a several form-fitting elements 40, here several lugs, which interact with corresponding form-fitting elements 47 on an outer contour of the housing 11. As a result, the second braking element 34 is secured against undesired rotation about the axis D.

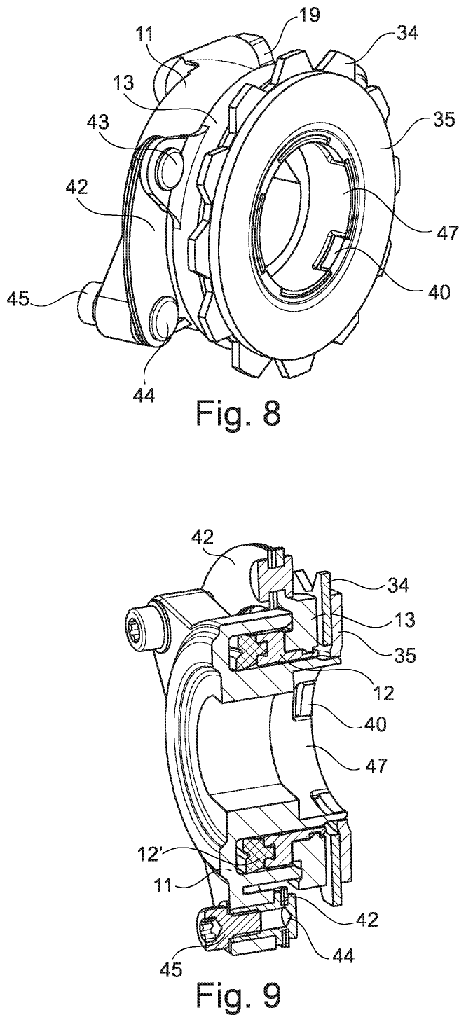

As can be seen in FIGS. 8 and 9, the braking device 10 has several, here two, leaf springs 42, by means of which the first braking element 13 can be moved from the braking position back into the rest position. The leaf springs 42 are arranged between the housing 11 and the first braking element 13. In this respect, the leaf springs fulfill a restoring function for the first braking element 13. In addition, the leaf springs also have a function in supporting the torque that occurs during braking. The leaf springs 42 extend around the axis D in a circumferential direction and can therefore absorb torques occurring during braking.

The leaf springs 42 are connected to each, to the housing 11 by means of a first rivet 44 and to the first braking element 13 by means of a second rivet. The first rivet 44 has an internal thread into which a screw 45 is screwed.

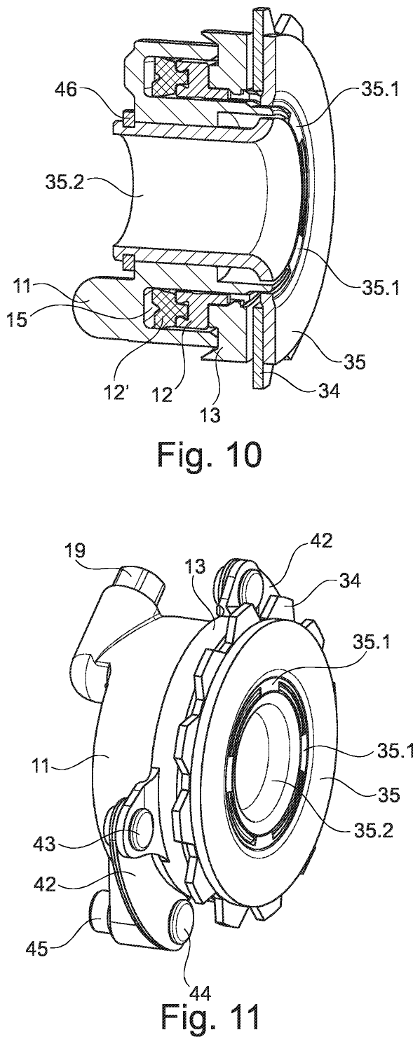

FIGS. 10 and 11 show a second exemplary embodiment of a braking device 10, which can alternatively be used in the vehicle according to FIG. 1. The braking device 10 according to the second exemplary embodiment essentially corresponds to that of the first exemplary embodiment so that reference is made to the description relating to the preceding figures. In contrast to the first exemplary embodiment, the second braking element 35 is integrally connected to a hollow-cylindrical assembly area 35.2 which is arranged concentrically around the axis D and is surrounded concentrically by the housing 11. The connection between the annular second braking element 35 and the assembly area 35.2 is established via several webs 35.1. The webs 35.1 here form form-fitting elements which interact with corresponding recesses on the housing 11 in order to prevent undesired rotation about the axis D during braking. However, by means of the assembly area 35.2, it is achieved that the flow of force runs past the axle support 6 during braking. The power flow during braking can be directed into the housing 11 through the sealing element 12′ and the brake piston 12, the first braking element 13, the brake disc 34, the second braking element 35, the webs 35.1, the hollow-cylindrical assembly area 35.2, a locking ring 46.

Due to the force flow described, which does not run through the axle support 6 or roller bearings 20, 21 of the wheel, the braking device 10 according to the second exemplary embodiment can be adapted to an existing drive system without the need to reinforce the axle support 6 or the roller bearings 20, 21.

The vehicle 1 described above, in the form of a skateboard, comprises at least one braking system 30 having at least one rotating element 5 rotatable about an axis D and a braking device 10 for braking the rotating element 5, wherein the braking device 10 has a first braking element 13 which can be moved between a rest position and a braking position and has an annular braking surface 13.1 which is arranged concentrically to the axis D of the rotating element 5 in the rest position and in the braking position. Furthermore, the braking system 30 comprises a brake disc 34 co-rotationally connected to the rotating element 5, having a first frictional surface 34.1 and a second frictional surface 34.2 opposite the first frictional surface 34.2, wherein the annular braking surface 13.1 of the first braking element 13 is arranged at a distance from the brake disc 34 in the rest position and is in contact with the first frictional surface 34.1 of the brake disc 34 in the braking position, and a second braking element 35 which is arranged such that the first braking element 13 presses the brake disc 34 against the second braking element 35 in the braking position so that the second braking element 35 is in contact with the second frictional surface 34.2 of the brake disc 34 in the braking position. According to a modification of the exemplary embodiment shown, the braking system 30 described can be part of a drive unit which has a rotating element formed as a drive wheel or drive pinion. Such drive units can be used, for example, in industrial systems, in particular in production systems, production robots, or conveyor systems.

### LIST OF REFERENCE SYMBOLS

1 Vehicle

2 Base body

3 Standing space

4 Axle support unit

5 Wheel

6 Axle portion

7 Tilting device

8 Engine

8′ Stator

9 Rotor

10 Braking device

11 Housing

12 Brake piston

12′ Sealing element

13 First braking element

13.1 Braking surface

15 Interior

18 Cable

20 Bearing

21 Bearing

30 Braking system

34 Brake disc

34.1 Frictional surface

34.2 Frictional surface

35 Second braking element

35.1 Web

35.2 Assembly area

36 Screw

38 Tooth

39 Bulge

40 Form-fitting element

41 Form-fitting element

42 Leaf spring

43 Rivet

44 Rivet

45 Screw

46 Securing ring

47 Form-fitting element

A Force flow path

D Axis

1. A braking system, comprising:
at least one rotating element rotatable about an axis; and
a braking device for braking the rotating element, the braking device including:
a first braking element which is movable between a rest position and a braking position and has an annular braking surface arranged concentrically to the axis of the rotating element in a rest position and in a braking position,
a brake disc co-rotationally connected to the rotating element, the brake disc having a first frictional surface and a second frictional surface opposite the first frictional surface,
wherein the annular braking surface of the first braking element is arranged at a distance from the brake disc in the rest position and is in contact with the first frictional surface of the brake disc in the braking position, and
a second braking element arranged such that the first braking element presses the brake disc against the second braking element in the braking position so that the second braking element is in contact with the second frictional surface of the brake disc in the braking position.

2. The braking system according to claim 1, wherein the first braking element is hydraulically movable between the rest position and the braking position.

3. The braking system according to claim 2, wherein the first braking element is connected to a hollow-cylindrical brake piston which is mounted in a housing which has a hollow-cylindrical interior for receiving a hydraulic fluid.

4. The braking system according to claim 1, wherein the braking device has one or more leaf springs by which the first braking element is movable from the braking position back into the rest position.

5. The braking system according to claim 4, wherein the one or more leaf springs extend around the axis in a circumferential direction.

6. The braking system according to claim 3, wherein the second braking element is formed annular and has first form-fitting elements on an inner contour, which cooperate with corresponding second form-fitting elements on an outer contour of the housing such that the second braking element is secured against rotation about the axis.

7. The braking system according to claim 3, wherein the second braking element is integrally connected to a hollow-cylindrical assembly area arranged concentrically around the axis and is surrounded concentrically by the housing.

8. An axle support unit for a vehicle, comprising a braking system according to claim 1, wherein the rotating element of the braking system is a wheel.

9. A vehicle comprising an axle support unit according to claim 8.

10. A drive unit, comprising a braking system according to claim 1, wherein the rotating element of the braking system comprises a drive element.

11. The drive unit according to claim 10, further comprising a drive motor arranged at least partially within the rotating element.

12. The braking system according to claim 6, wherein the first form fitting elements are teeth or wedges.

13. The drive unit of claim 10, wherein the drive element is a drive wheel or a drive pinion.

14. A braking system, comprising:
a rotating element that is rotatable about an axis; and
a braking device for braking the rotating element, the braking device including:
a first braking element which is movable between a rest position and a braking position and has a braking surface arranged at least partially about the axis of the rotating element,
a brake disc co-rotationally connected to the rotating element, the brake disc having a first frictional surface and a second frictional surface opposite the first frictional surface,
wherein the braking surface of the first braking element is arranged at a distance from the brake disc in the rest position and is in contact with the first frictional surface of the brake disc in the braking position, and
a second braking element arranged such that the first braking element presses the brake disc against the second braking element in the braking position so that the second braking element is in contact with the second frictional surface of the brake disc in the braking position.

15. The braking system according to claim 14, wherein the first braking element is hydraulically movable between the rest position and the braking position.

16. The braking system according to claim 15, further comprising a housing which has a hollow-cylindrical interior for receiving a hydraulic fluid, a hollow-cylindrical brake piston mounted in the housing, and the first braking element is connected to a hollow-cylindrical brake piston.

17. The braking system according to claim 14, wherein the braking device has one or more leaf springs by which the first braking element is movable from the braking position back into the rest position.

18. The braking system according to claim 17, wherein the one or more leaf springs extend around the axis in a circumferential direction.

19. The braking system according to claim 16, wherein the second braking element is formed annular and has first form-fitting elements on an inner contour, which cooperate with corresponding second form-fitting elements on an outer contour of the housing such that the second braking element is secured against rotation about the axis.

20. The braking system according to claim 16, wherein the second braking element is integrally connected to a hollow-cylindrical assembly area arranged concentrically around the axis and is surrounded concentrically by the housing.
